(19) United States
(12) Patent Application Publication
(10) Pub. No.: US 2006/0132441 A1
(43) Pub. Date: Jun. 22, 2006

(54) Computer mouse having cable collecting structure

(75) Inventor: Chun-Chung Huang, Taipei City (TW)

Correspondence Address: SNELL & WILMER;ONE ARIZONA CENTER, 400 EAST VAN BUREN, PHOENIX, AZ, 850040001, US

(73) Assignee: Darfon Electronics Corp.

(21) Appl. No.: 11/299,515

(22) Filed: Dec. 12, 2005

(30) Foreign Application Priority Data
Dec. 17, 2004 (TW) 93220359

(51) Int. Cl. G09G 5/08

(52) U.S. Cl. 345/163

(57) ABSTRACT

A computer mouse having a cable collecting structure is provided. The computer mouse includes a body, a cable, and a first button. The body has a top portion, a bottom portion and a first groove. The first groove is located in the top and/or bottom portion and the first groove extends along a longitudinal direction of the body. The cable, having an end connected to the body, can be wound around the body and at least partially received in the first groove. The first button is located on the top portion. The lengthwise direction of the first groove and that of the first button are substantially parallel to each other.

### CROSS-REFERENCE TO RELATED APPLICATIONS

This Application claims the right of priority based on Taiwan Patent Application No. 93220359 entitled “COMPUTER MOUSE HAVING CABLE COLLECTING STRUCTURE” filed on Dec. 17, 2004, which is incorporated herein by reference.

### FIELD OF INVENTION

The present invention generally relates to a computer mouse and, more particularly, to a computer mouse having a cable collecting structure, which includes a groove extending along a longitudinal direction of the body of the computer mouse such that the cable can be received into the groove.

### BACKGROUND OF THE INVENTION

In early days, it was unpopular for a computer mouse to include a cable collecting structure for receiving the cable, although such a structure enables a user to save the cable space and to carry the computer mouse easily. However, as notebook computers become popular, the demand of portability for the peripheral devices of the notebook computers increases. Thus, manufacturers have endeavored to improve the functionalities of the computer mice in order to satisfy the demand of the portability.

There are a variety of computer mice in the market, such as a computer mouse having a cable collecting structure on its bottom portion for receiving its cable, or a computer mouse with a cable being collected and received by transversely winding it around the mouse body. However, these computer mice still have some disadvantages. For example, a conventional computer mouse lacks a space to accommodate the connector attached with the cable, or one needs to disassemble the housing of the computer mouse in order to accommodate the cable and the connector.

Therefore, it would be desirable to create a computer mouse with a cable collecting structure, which benefits users not only the space saving and the ease of carrying, but also the manipulation simpleness for receiving the cable and the connectors attached with it.

### SUMMARY OF THE INVENTION

The present invention provides a computer mouse having a cable collecting structure. The body of the computer mouse forms a first groove extending along a longitudinal direction of the body, so that the cable can be wound around the body as well as being received into the first groove of the computer mouse. Accordingly, the volume of the whole computer mouse including the cable is reduced so that the portability convenience for the computer mouse is improved. Furthermore, because of the configuration of the cable collecting structure, the cable with its connector can be easily received as well.

### BRIEF DESCRIPTION OF THE DRAWINGS

FIG. 1 shows a front view of a computer mouse in accordance with the present invention.

FIGS. 2A-2B respectively show a rear view of a computer mouse in accordance with the present invention.

### DETAILED DESCRIPTION

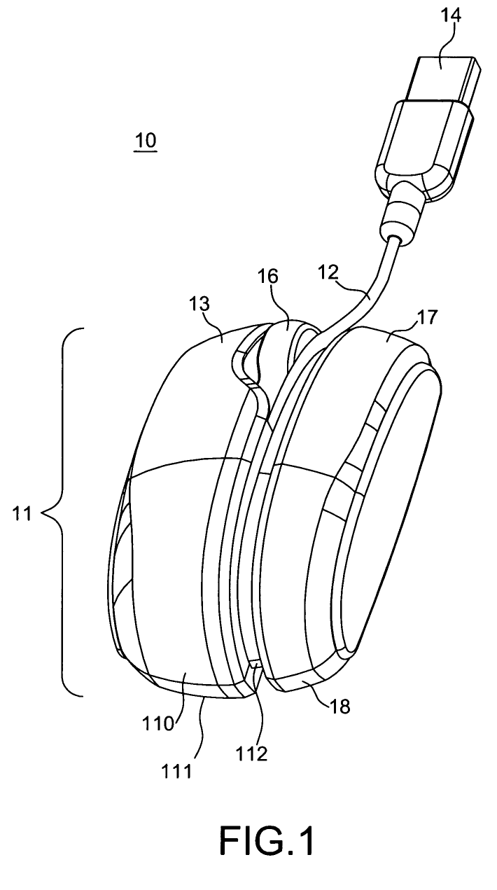

FIG. 1 shows a computer mouse 10 having a cable collecting structure in accordance with the present invention. Referring to FIG. 1, the computer mouse 10 includes a body 11, a cable 12 and a first button 13. The body 11 includes as a top portion 110, a bottom portion 111 and a lateral portion 18. A first groove 112 forms a collar gap around the body 11 by extending along the longitudinal direction of the body 11 and traversing the top portion 110, the bottom portion 111, and the lateral portion 18. The cable 12 has an end connected to the body 11 and another end coupled with a connector 14. The first button 13 is located on the top portion 110. When the computer mouse 10 is in a receiving situation, the cable 12 is wound around the body 11 along the longitudinal direction and received in the first groove 112. When the computer mouse 10 is in an operation situation, the cable 12 is pulled out of the first groove 112 for use. As shown in FIG. 1, the lengthwise direction of the first groove 112 and the lengthwise direction of the first button 13 are substantially parallel to each other. Due to the configuration of the collecting structure in the computer 10, a user can conveniently receive the cable 12 through the route as pulling the cable 12 out of the body 11 along the first groove 112 so that the cable 12 is substantially stored in the body 11. Therefore, the computer mouse 10 in the receiving situation is easy to carry because the whole size of the computer mouse 10 including the cable 12 in the receiving situation is nearly the same as the size of the body 11.

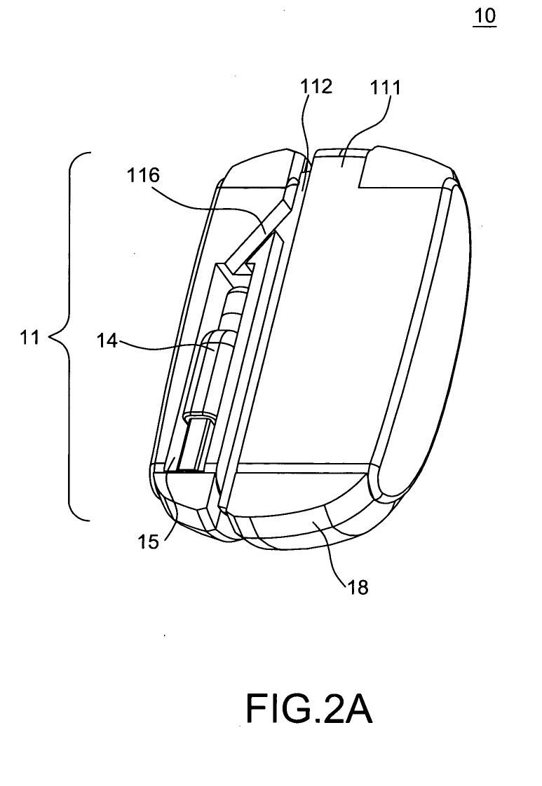

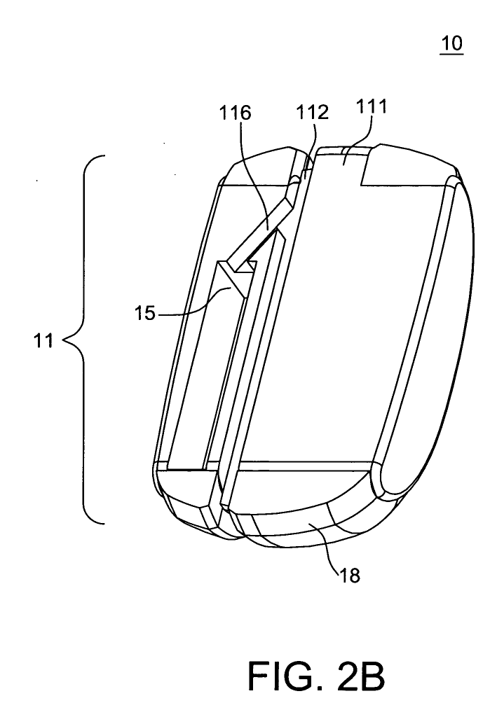

FIGS. 2A-2B respectively shows a rear view of the computer mouse 10 in accordance with the present invention. Referring to FIG. 2A, the computer mouse 10 further includes a space 15 located on the bottom portion 111 and a second groove 116 for connecting the first groove 112 with the space 15. When winding the cable 12 around the body 11 along the groove 112 is accomplished, a user can further put the connector 14 into the space 15 by the guidance of the second groove 116. As shown in FIG. 2B, the space 15 is shaped to fit the contour of the connector 14 so that the connector 14 is not easily falling after being inserted into the space. It would be appreciated by those skilled in the art that the space 15 can also be set in the top potion 110 or the lateral portion 18 depending on the variety of the computer mouse 10. Similarly, the position of the second groove 112 can vary with the diverse placements of the space 15. Furthermore, the connector 14 in this embodiment is a USB connector. However, the connector 14 can be a PS/2 connector or any other type of connector for connecting the cable 12 with an electronic apparatus. Likewise, the shape of the space 15 in the body 11 is formed based on the contour of the connector 14.

Referring to FIG. 1, in this embodiment of the present invention, the computer mouse 10 further includes a wheel 16 located between the first button 13 and the first groove 112. The turning direction of the wheel 16 parallels the lengthwise direction of the first groove 112. The computer mouse 10 further includes a second button 17. The first button 13 and the second button 17 are respectively located at the opposite sides of the first groove 112. In this embodiment, the size of the first button 13 is nearly the same as that of the second button 17. In other words, the first groove 112 extends about at the center of the body 11 along the longitudinal direction of the body 11. However, in other embodiments of the present invention, the first groove 112 can be set closer to the lateral portion 18 rather than just in the center of the body 11, and the lengthwise direction of the first groove 112 can be non-linear around the body 11, such that the first button 13 and the second button 17 are asymmetrically located on the body 11.

The present invention has been described above with reference to preferred embodiments. However, those skilled in the art can understand that the scope of the present invention need not be limited to the disclosed preferred embodiments. On the contrary, it is intended to cover various modifications and equivalent arrangements within the scope defined in the following appended claims. The scope of the claims should be accorded the broadest interpretation so as to encompass all such modifications and equivalent arrangements.

I claim:

1. A computer mouse having a cable collecting structure, said computer mouse comprising:
a body, having a top portion, a bottom portion, and a first groove located in said top portion and/or said bottom portion, said first groove extending along a longitudinal direction of said body;
a cable, being windable around said body and at least partially received in said first groove, said cable having an end connected to said body; and
a first button, located on said top portion;
wherein a lengthwise direction of said first groove and a lengthwise direction of said first button are substantially parallel to each other.

2. The computer mouse of claim 1, further comprising a connector coupling with another end of said cable.

3. The computer mouse of claim 2, wherein said body further comprises a space to receive said connector when the cable is wound around said body.

4. The computer mouse of claim 3, wherein said space is located in said bottom portion.

5. The computer mouse of claim 4, wherein said bottom portion further comprises a second groove for connecting said first groove with said space, and said second groove guides said connector into said space.

6. The computer mouse of claim 2, wherein said connector is a USB connector.

7. The computer mouse of claim 2, wherein said connector is a PS/2 connector.

8. The computer mouse of claim 1, wherein said body further comprises a wheel located between said first button and said first groove.

9. The computer mouse of claim 1, wherein said body further comprises a second button, and said first button and said second button are respectively located at opposite sides of said first groove.

10. The computer mouse of claim 1, wherein said body further comprises a lateral portion, and said first groove traverses said first top portion, said lateral portion, and said bottom portion.

11. A computer mouse having a cable collecting structure, comprising:
a body, formed with a first groove extending around said body;
a cable, having an end connected to said body and another end connected to a connector, said cable windable around said body and at least partially received in said first groove; and
a space for receiving said connector, said space being selectively located at a side of said body;
wherein a lengthwise direction of said first groove and a lengthwise direction of said first button are substantially parallel to each other.

12. The computer mouse of claim 11, wherein said body further forms a second groove for connecting said first groove with said space, and said second groove guides said connector into said space.

13. The computer mouse of claim 11, wherein said connector is a USB connector.

14. The computer mouse of claim 11, wherein said connector is a PS/2 connector.

15. The computer mouse of claim 11, wherein said body further comprises a wheel located aside said first groove and substantially parallel to said first groove.

16. The computer mouse of claim 1, wherein said body further comprises two buttons respectively located at opposite sides of said first groove.
